(19) United States
(12) Patent Application Publication
(10) Pub. No.: US 2008/0036911 A1
(43) Pub. Date: Feb. 14, 2008

(54) Method and apparatus for synchronizing a graphics signal according to a reference signal

(76) Inventors: Robert Noory, IIe Bizard (CA); Sylvain Marcotte, Pierrefonds (CA)

Correspondence Address: OGILVY RENAULT LLP, 1981 MCGILL COLLEGE AVENUE, SUITE 1600, MONTREAL, QC, H3A2Y3, CA

(21) Appl. No.: 11/418,115

(22) Filed: May 5, 2006

(51) Int. Cl. H04N 11/00

(52) U.S. Cl. 348/468

(57) ABSTRACT

A method for synchronizing a graphics signal provided by a graphics generating unit according to a video reference signal, the method comprising receiving the graphics signal, receiving the video reference signal, comparing the graphics signal with the video reference signal to provide an error signal indicative of a synchronization between the video reference signal and the reference signal and using the error signal to perform a compensation at the graphics generating unit to provide a synchronized graphics signal.

### CROSS-REFERENCE TO RELATED APPLICATIONS

This is the first application filed for the present invention.

### TECHNICAL FIELD

This invention relates to the field of graphics. More precisely, this invention pertains to a method and apparatus for synchronizing a graphics signal according to a reference signal.

### BACKGROUND OF THE INVENTION

Equipments handling video, such as video editing apparatus, require to be synchronized with a video reference signal.

The video reference signal is used to synchronize each equipment to avoid a desynchronization of an equipment with respect to others which could lead to the creation of visible artifacts which are not acceptable in a professional application. Unfortunately, synchronizing each equipment of a plurality of equipments can be cumbersome.

There is a need for a method and apparatus for synchronizing a graphics signal using a video reference signal.

### SUMMARY OF THE INVENTION

According to one aspect of the invention, there is provided a method for synchronizing a graphics signal provided by a graphics generating unit according to a reference signal, the method comprising receiving the graphics signal, receiving the video reference signal, comparing the graphics signal with the video reference signal to provide an error signal indicative of a synchronization between the graphics signal and the video reference signal and using the error signal to perform a compensation of the graphics signal at the graphics generating unit to provide a synchronized graphics signal.

According to another aspect of the invention, there is provided an apparatus for synchronizing a graphics signal provided by a graphics generating unit according to a video reference signal, the apparatus comprising a comparing unit for receiving the graphics signal and the video reference signal and providing an error signal indicative of a synchronization between the graphics signal and the video reference signal and a compensating unit for receiving the error signal and generating a corresponding control signal for controlling the graphics generating unit such that the graphics signal is synchronized with the video reference signal.

### BRIEF DESCRIPTION OF THE DRAWINGS

Further features and advantages of the present invention will become apparent from the following detailed description, taken in combination with the appended drawings, in which:

FIG. 1 is a block diagram which shows a system in which an apparatus is used for synchronizing a graphics signal provided by a graphics generating unit according to a reference signal;

FIG. 2 is a block diagram which shows one embodiment of the apparatus for synchronizing a graphics signal generated by a raster generator according to a reference signal; the apparatus comprises a compensating unit and a comparing unit;

FIG. 3 is a block diagram which shows an embodiment of the raster generator;

FIG. 4 is a block diagram which shows an embodiment of the comparing unit;

FIG. 5 is a block diagram which shows an embodiment of the compensating unit;

FIG. 6 is a flowchart which shows an embodiment for synchronizing the graphics signal according to the reference signal; the graphics signal and the reference signal are provided, a comparison is then performed between the graphics signal and the reference signal to provide a corresponding error signal and a compensation is performed using the error signal;

FIG. 7 is a flowchart which shows how a vertical compensation is performed according to one embodiment;

FIG. 8 is a flowchart which shows how an horizontal compensation is performed according to one embodiment; and

FIG. 9 is a flowchart which shows how a pixel frequency compensation is performed according to one embodiment.

It will be noted that throughout the appended drawings, like features are identified by like reference numerals.

### DETAILED DESCRIPTION OF THE PREFERRED EMBODIMENT

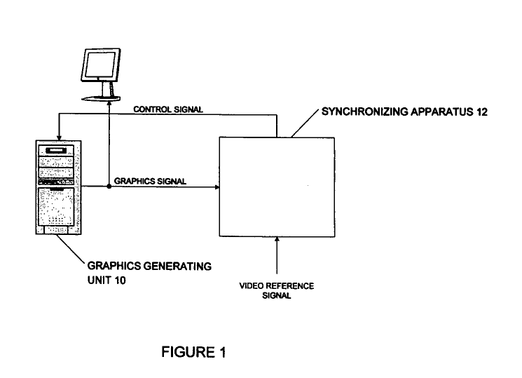

Now referring to FIG. 1, there is shown an embodiment of a system in which a synchronizing apparatus 12 is provided for synchronizing a graphics signal provided by a graphics generating unit 10 according to a video reference signal.

The graphics generating unit 10 generates a graphics signal. The synchronizing apparatus 12 receives the generated graphics signal and a video reference signal. The synchronizing apparatus 12 further provides a control signal to the graphics generating unit 10.

In one embodiment, the graphics generating unit 10 comprises a graphics card connected to a computer. Alternatively, the graphics generating unit 10 may be an embedded graphics engine.

In one embodiment, the graphics signal provided by the graphics generating unit 10 may be anyone of an analog and a digital graphics signal. For instance, the graphics signal may be selected from a group consisting of an analog graphics signal VGA style, a DVI (digital video interface), an HDMI signal or the like.

It will be appreciated that the video reference signal may be, in one embodiment, anyone of a digital signal and an analog signal, such as, for instance, a composite analog signal, a NTSC/PAL signal, a tri-level synchronization signal or the like. Still in one embodiment, the video reference signal is provided by a video reference signal distribution unit.

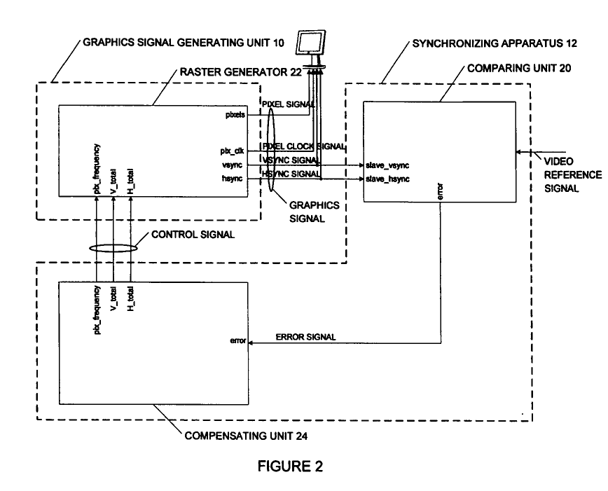

Referring to FIG. 2, there is shown an embodiment of the system comprising the synchronizing apparatus 12 which is provided for synchronizing the graphics signal provided by the graphics generating unit 10 according to the video reference signal.

In the embodiment disclosed, the graphics signal generating unit 10 comprises a raster generator 22. The synchronizing apparatus 12 comprises a comparing unit 20 and a compensating unit 24.

The raster generator 22 is used for generating the graphics signal using a control signal.

In the embodiment disclosed, the graphics signal comprises a pixel signal, a pixel clock signal, a vertical synchronization (vsync) signal and an horizontal synchronization (hsync) signal.

Still in the embodiment shown in FIG. 2, the control signal comprises a pixel frequency signal, a vertical total pixel signal and an horizontal total pixel signal. The pixel frequency signal is indicative of a frequency for generating the pixels while the vertical total pixel signal and the horizontal total pixel signal are respectively indicative of a number of pixels to generate in a vertical line and a number of pixels to generate in an horizontal line.

The compensating unit 24 is used to compensate a signal.

In the embodiment disclosed in FIG. 2, the compensating unit 24 receives the error signal provided by the comparing unit 20 and generates the control signal comprising the pixel frequency signal, the vertical total pixel signal and the horizontal total pixel signal.

In the embodiment disclosed, the compensating unit 24 is software implemented which is compiled according to an operating system used for operating the graphics signal generating unit 10. Alternatively, the compensating unit 24 is implemented in hardware.

The comparing unit 20 is used to compare the graphics signal with the video reference signal.

The comparing unit 20 receives the vertical synchronization signal and the horizontal synchronization signal. The comparing unit 20 further receives the video reference signal comprising in one embodiment a master clock signal and a master synchronization signal (not shown in FIG. 2). The comparing unit 20 provides an error signal. The error signal is provided to the compensating unit 24.

In the embodiment disclosed, the comparing unit 20 is implemented using processing unit such as a dedicated hardware circuit, a Field Programmable Array Gate (FPGA) circuit, a Digital Signal Processor (DSP) or the like.

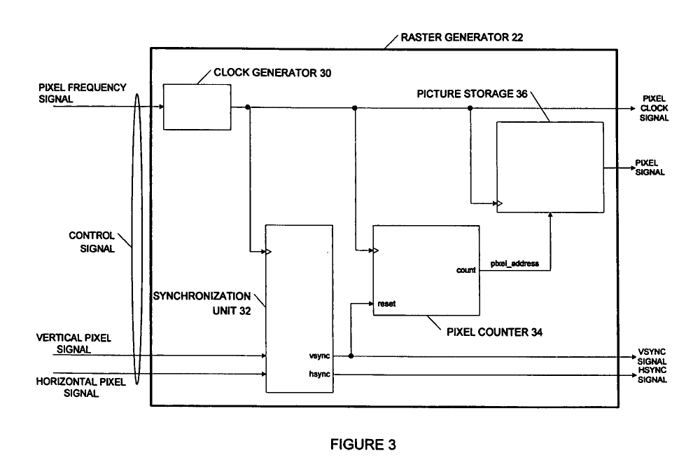

Now referring to FIG. 3, there is shown an embodiment of the raster generator 22.

In this embodiment, the raster generator 22 comprises a clock generator 30, a synchronization unit 32, a pixel counter 34 and a picture storage 36.

The clock generator 30 is used for generating a pixel clock signal. More precisely, the clock generator receives the pixel frequency signal and provides the pixel clock signal.

The synchronization unit 32 is used for providing signals synchronized with a given clock. More precisely, the synchronization unit 32 receives the vertical pixel signal and the horizontal pixel signal and the generated pixel clock signal and provides the vertical synchronization signal and the horizontal synchronization signal.

The pixel counter 34 is used for counting pixels. More precisely, the pixel counter 34 is clocked by the pixel clock signal and is reset using the vertical synchronization signal. The pixel counter 34 provides a pixel address signal which is provided to the picture storage 36.

The picture storage 36 is used to store picture and to provide data according to a request. More precisely, the picture storage 36 is clocked by the pixel clock signal and further receives the pixel address signal provided by the pixel counter 34. In response, the picture storage 36 provides the pixel signal.

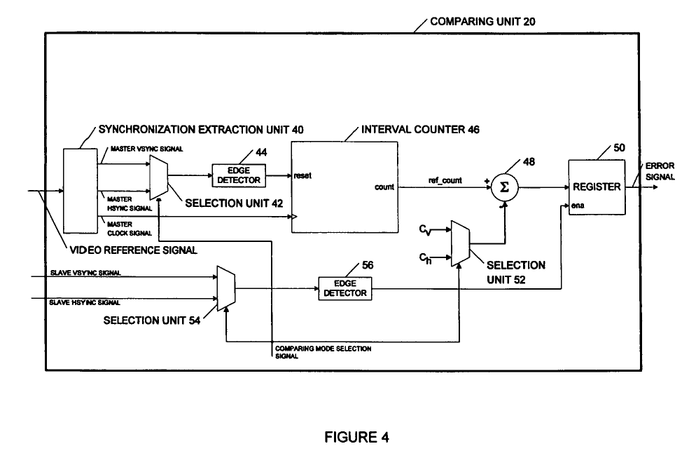

Now referring to FIG. 4, there is shown an embodiment of the comparing unit 20.

The comparing unit 20 comprises a synchronization extraction unit 40, a selection unit 42, an edge detector 44, an interval counter 46, a summation unit 48, a register 50, a selection unit 52, a selection unit 54 and an edge detector 56.

The synchronization extraction unit 40 is used to extract synchronization signals from a video reference signal. More precisely, the synchronization extraction unit 40 receives the video reference signal and provides a master vertical synchronization signal, a master horizontal synchronization signal and a master clock signal.

The selection unit 42 is used to select one of two signals. More precisely, the selection unit 42 is used to select one of a master vertical synchronization signal and a master horizontal synchronization signal according to a comparing mode selection signal. The selection unit 42 provides a selected signal.

The edge detector 44 is used to detect the edge of a signal provided. More precisely, the edge detector 44 receives a selected one of the master vertical synchronization signal and the master horizontal synchronization signal and provides a signal indicative of an edge detection to the interval counter 46.

The interval counter 46 further receives the master clock signal and is reset according to the signal indicative of an edge detection.

The interval counter 46 provides a reference count signal to the summation unit 48. The reference count signal is indicative of the number of master clock cycles between two master vertical synchronizations or the number of master clock cycles between two master horizontal synchronizations depending on the comparing mode selection signal provided to the selection unit 42.

The selection unit 52 is used to select one of two signals according to the comparing mode selection signal. More precisely, the selection unit 52 is used to select one of a vertical constant Cv and an horizontal constant Ch. The vertical constant Cv is a number comprised between one and the number of reference clock cycles between two vertical synchronization signals. In one embodiment, the vertical constant Cv is equal to a number of reference clock cycles between two vertical synchronization signals divided by two. The constant Ch is a number comprised between one and the number of reference clock cycles between two horizontal synchronization signals. In one embodiment, the constant Ch is equal to a number of reference clock cycles between two horizontal synchronization signals divided by two.

The selection unit 52 provides the selected one of the vertical constant Cv and the horizontal constant Ch to the summation unit 48.

The summation unit 48 subtracts the selected one of the vertical constant Cv and the horizontal constant Ch to the reference count signal.

The selection unit 54 is used to select one of two signals according to the comparing mode selection signal. More precisely, the selection unit 54 is used to select one of the slave vertical synchronization signal and the slave horizontal synchronization signal.

The edge detector 56 is used to detect an edge. More precisely, the edge detector 56 receives the selected one of the slave vertical synchronization signal and the slave horizontal synchronization signal and provides a signal indicative of an edge detected.

The signal indicative of the edge detected is provided to the enable input of the register 50.

The register 50 provides the error signal.

The skilled addressee will appreciate that the embodiment disclosed in FIG. 4 is one exemplary embodiment of the comparing unit 20 and that various other embodiments may be provided.

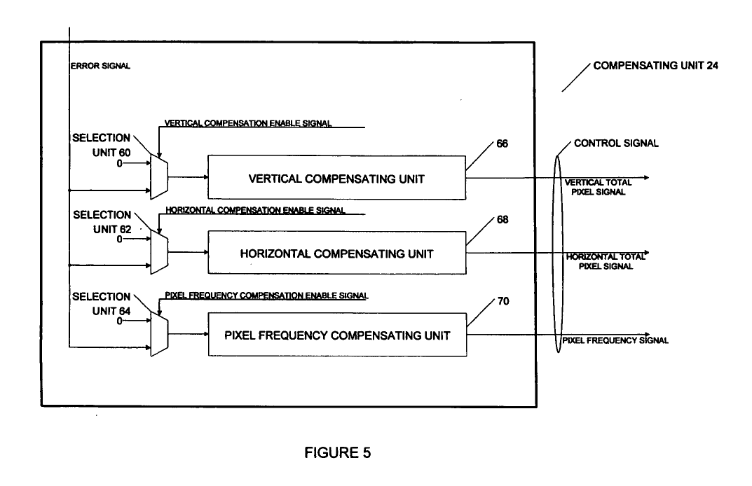

Now referring to FIG. 5, there is shown an embodiment of the compensating unit 24.

The compensating unit 24 comprises, in one embodiment, a first selection unit 60, a second selection unit 62, a third selection unit 64, a vertical compensating unit 66, an horizontal compensating unit 68 and a pixel frequency compensating unit 70.

The first selection unit 60 is used to select one of two signals. More precisely, the first selection unit 60 is used to select one of the error signal and a 0 signal according to a vertical compensation enable signal.

Similarly, the second selection unit 62 is used to select one of two signals. More precisely, the second selection unit 62 is used to select one of the error signal and a 0 signal according to an horizontal compensation enable selection signal.

Finally, the third selection unit 64 is used to select one of two signals. More precisely, the third selection unit 64 is used to select one of the error signal and a 0 signal according to a pixel frequency compensation enable selection signal.

The skilled addressee will appreciate that the compensating unit 24 may alternatively comprise at least one of the vertical compensating unit 66, the horizontal compensating unit 68 and the pixel frequency compensating unit 70.

The vertical compensating unit 66 is used for vertical compensation. More precisely, the vertical compensating unit 66 is used to provide a vertical total pixel signal to the graphics signal generating unit 10. The vertical total pixel signal is generated using at least the selected one of the 0 signal and the error signal.

The horizontal compensating unit 68 is used for horizontal compensation. More precisely, the horizontal compensating unit 68 is used to provide an horizontal total pixel signal to the graphics signal generating unit 10. The horizontal total pixel signal is generated using at least the selected one of the 0 signal and the error signal.

The horizontal compensating unit 70 is used for pixel frequency compensation. More precisely, the horizontal compensating unit 70 is used to provide a pixel frequency signal to the graphics signal generating unit 10. The pixel frequency signal is generated using at least the selected one of the 0 signal and the error signal.

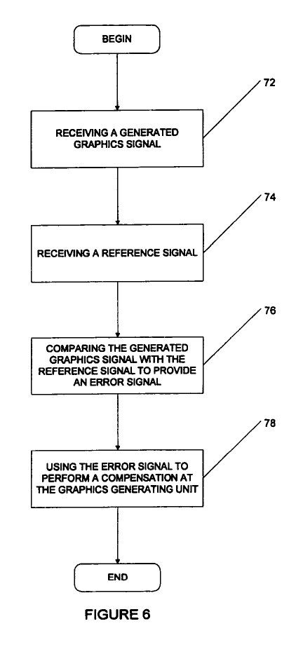

Now referring to FIG. 6, there is shown an embodiment for synchronizing the graphics signal according to the reference signal.

According to step 72, a generated graphics signal is received.

According to step 74, a reference signal is received. As explained above, the video reference signal may be received, in one embodiment, from a video reference signal distribution unit

According to step 76, the generated graphics signal is compared with the reference signal to provide an error signal.

According to step 78, the error signal is used to perform a compensation at the graphics generating unit. The skilled addressee will appreciate that at least one of a vertical compensation, an horizontal compensation and a pixel frequency compensation may be performed.

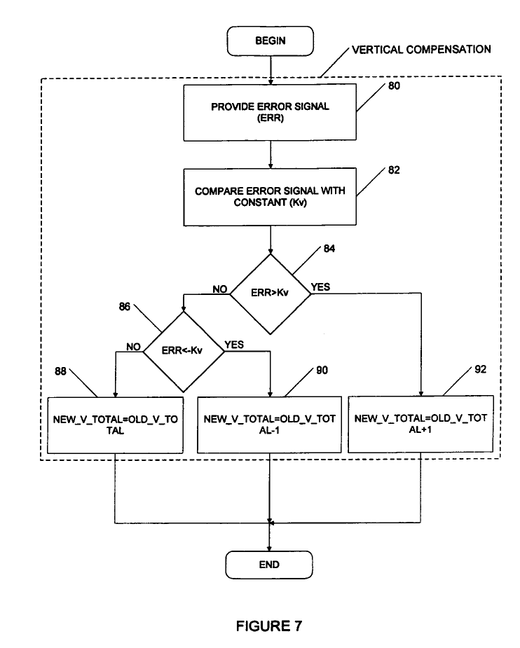

Now referring to FIG. 7, there is shown an embodiment for performing a vertical compensation.

According to step 80, an error signal is provided.

According to step 82, the error signal is compared with a constant Kv.

According to step 84, a test is performed in order to find out if the error signal is greater than the constant Kv.

In the case where the error signal is greater than the constant Kv and according to step 92, the new value of the vertical total pixel is equal to the old value of the vertical total pixel plus one.

In the case where the error signal is smaller than the constant Kv, a test is performed according to step 86 to find out if the error is smaller than minus the constant Kv.

In the case where the error is smaller than minus the constant Kv and according to step 90, the new value of the vertical total pixel is equal to the old value of the vertical total pixel minus one.

In the case where the error is not smaller than minus the constant Kv and according to step 88, the new value of the vertical total pixel is equal to the old value of the vertical total pixel.

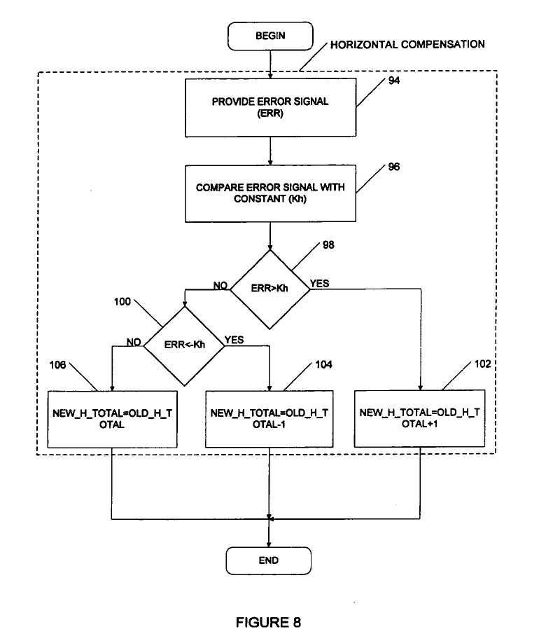

Now referring to FIG. 8, there is shown an embodiment for performing an horizontal compensation.

According to step 94, an error signal is provided.

According to step 96, the error signal is compared with a constant Kh.

According to step 98, a test is performed in order to find out if the error signal is greater than the constant Kh.

In the case where the error signal is greater than the constant Kh and according to step 102, the new value of the horizontal total pixel is equal to the old value of the horizontal total pixel plus one.

In the case where the error signal is smaller than the constant Kh, a test is performed according to step 100 to find out if the error is smaller than minus the constant Kh.

In the case where the error is smaller than minus the constant Kh and according to step 104, the new value of the horizontal total pixel is equal to the old value of the horizontal total pixel minus one.

In the case where the error is not smaller than minus the constant Kh and according to step 106, the new value of the horizontal total pixel is equal to the old value of the horizontal total pixel.

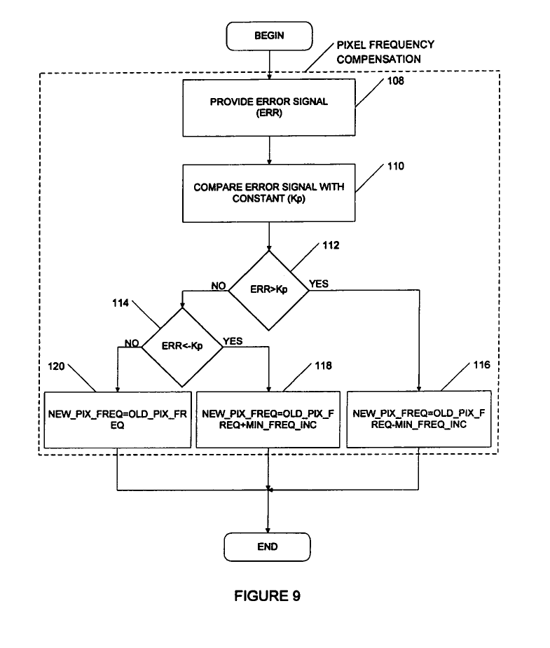

Now referring to FIG. 9, there is shown an embodiment for performing a pixel frequency compensation.

According to step 108, an error signal is provided.

According to step 110, the error signal is compared with a constant Kp.

According to step 112, a test is performed in order to find out if the error signal is greater than the constant Kp.

In the case where the error signal is greater than the constant Kp and according to step 116, the new value of the pixel frequency is equal to the old value of the pixel frequency minus a minimum pixel frequency. It will be appreciated that the minimum pixel frequency is selected depending on the raster generator unit used. The skilled addressee will appreciate that it might be appropriate to have the minimum pixel frequency as small as possible.

In the case where the error signal is smaller than the constant Kp, a test is performed according to step 114 to find out if the error is smaller than minus the constant Kp.

In the case where the error is smaller than minus the constant Kp and according to step 118, the new value of the pixel frequency is equal to the old value of the pixel frequency plus a minimum pixel frequency.

In the case where the error is not smaller than minus the constant Kp and according to step 120, the new value of the pixel frequency is equal to the old value of the pixel frequency.

While illustrated in the block diagrams as groups of discrete components communicating with each other via distinct data signal connections, it will be understood by those skilled in the art that the preferred embodiments are provided by a combination of hardware and software components, with some components being implemented by a given function or operation of a hardware or software system, and many of the data paths illustrated being implemented by data communication within a computer application or operating system. The structure illustrated is thus provided for efficiency of teaching the present preferred embodiment.

It should be noted that the present invention can be carried out as a method, can be embodied in a system, a computer readable medium or an electrical or electro-magnetical signal.

The embodiment(s) of the invention described above is(are) intended to be exemplary only. The scope of the invention is therefore intended to be limited solely by the scope of the appended claims.

We claim:

1. A method for synchronizing a graphics signal provided by a graphics generating unit according to a reference signal, said method comprising:
receiving said graphics signal;
receiving said video reference signal;
comparing said graphics signal with said video reference signal to provide an error signal indicative of a synchronization between said graphics signal and said video reference signal; and
using said error signal to perform a compensation of said graphics signal at said graphics generating unit to provide a synchronized graphics signal.

2. The method as claimed in claim 1, wherein said using of said error signal to perform a compensation comprises performing at least one of an horizontal pixel compensation, a vertical pixel compensation and a pixel frequency compensation.

3. The method as claimed in claim 1, wherein said graphics signal comprises one of an analog and a digital graphics signal provided by a raster generator.

4. The method as claimed in claim 1, further comprising providing said video reference signal from a video reference signal distribution unit.

5. The method as claimed in claim 1, wherein said video reference signal comprises an horizontal synchronization signal and a vertical synchronization signal, further wherein said comparing of said graphics signal with said video reference signal comprises selecting at least one of said horizontal synchronization signal and said vertical synchronization signal to use and comparing the selected one with a corresponding one of an horizontal constant and a vertical constant.

6. The method as claimed in claim 5, wherein said vertical constant is a number comprised between 1 and the number of clock cycles between two vertical synchronization signals of said graphics signal minus one.

7. The method as claimed in claim 5, wherein said horizontal constant is a number comprised between 1 and the number of clock cycles between two horizontal synchronization signals of said graphics signal minus one.

8. The method as claimed in claim 2, wherein said compensation is performed depending on a raster generator providing said graphics signal.

9. The method as claimed in claim 2, wherein said vertical pixel compensation comprises comparing said error signal with a constant wherein when said error signal is greater than said constant, providing a new vertical signal greater than a previous provided vertical signal; when said error signal is less than minus said constant, providing a new vertical signal having a value lower than said previous provided vertical signal; else providing a new vertical signal equal to said previous provided vertical signal.

10. The method as claimed in claim 2, wherein said horizontal pixel compensation comprises comparing said error signal with a constant, wherein when said error signal is greater than said constant, providing a new horizontal signal greater than a previous provided horizontal signal; when said error signal is less than minus said constant, providing a new horizontal signal having a value lower than said previous provided horizontal signal; else providing a new horizontal signal equal to said previous provided horizontal signal.

11. The method as claimed in claim 2, wherein said pixel frequency compensation comprises comparing said error signal with a constant wherein when said error signal is greater than said constant, providing a new pixel frequency signal having a value lower than a previous provided pixel frequency signal; when said error signal is less than minus said constant, providing a new pixel frequency signal greater than said previous provided pixel frequency signal; else providing a new pixel frequency signal equal to said previous provided pixel frequency signal.

12. An apparatus for synchronizing a graphics signal provided by a graphics generating unit according to a video reference signal, said apparatus comprising:
a comparing unit for receiving said graphics signal and said video reference signal and providing an error signal indicative of a synchronization between said graphics signal and said video reference signal; and
a compensating unit for receiving said error signal and generating a corresponding control signal for controlling said graphics generating unit such that said graphics signal is synchronized with said video reference signal.

13. The apparatus as claimed in claim 12, wherein said video reference signal comprises at least one of an horizontal synchronization signal and a vertical synchronization signal.

14. The apparatus as claimed in claim 13, wherein said video reference signal comprises the horizontal synchronization signal and the vertical synchronization signal, further wherein said comparing unit further comprises a selection unit for receiving said horizontal synchronization signal and said vertical synchronization signal and providing a selected one of said horizontal synchronization signal and said vertical synchronization signal according to a comparing mode selection signal.

15. The apparatus as claimed in claim 14, wherein said comparing unit further comprises an interval counter for receiving said selected one of said horizontal synchronization signal and said vertical synchronization signal and for providing a reference count signal indicative of an amount of clock cycles between two consecutives one of said selected one of said horizontal synchronization signal and said vertical synchronization signal, further wherein said reference count signal is compared to a corresponding one of an horizontal constant and a vertical constant to provide said error signal.

16. The apparatus as claimed in claim 15, wherein said horizontal constant is a number comprised between 1 and the number of clock cycles between two horizontal synchronization signals of said graphics signal.

17. The apparatus as claimed in claim 15, wherein said vertical constant is a number comprised between 1 and the number of clock cycles between two vertical synchronization signals of said graphics signal.

18. The apparatus as claimed in claim 15, wherein said comparing unit is further for subtracting said corresponding one of an horizontal constant and a vertical constant to said reference count signal to provide a subtracted signal and further providing said subtracted signal to a register for outputting said error signal.

19. The apparatus as claimed in claim 14, wherein said comparing unit further comprises a synchronization extraction unit for receiving said video reference signal and for providing said horizontal synchronization signal and said vertical synchronization signal.

20. The apparatus as claimed in claim 12, wherein said compensating unit comprises at least one of an horizontal compensating unit for receiving said error signal and for outputting an horizontal signal, a vertical compensating unit for receiving said error signal and for outputting a vertical signal, and a pixel frequency compensating unit for receiving said error signal and for outputting a pixel frequency signal.

21. The apparatus as claimed in claim 12, further comprising a raster generator for providing said graphics signal, said graphics signal comprises one of an analog and a digital graphics signal.

22. The apparatus as claimed in claim 12, wherein said video reference signal is provided by a video reference signal distribution unit.
